(19) United States
(12) Patent Application Publication
(10) Pub. No.: US 2019/0258969 A1
(43) Pub. Date: Aug. 22, 2019

(54) RIDE CHAINING FOR LONG DISTANCE TRAVEL

(71) Applicant: International Business Machines Corporation, Armonk, NY (US)

(72) Inventors: Ben Z. Akselrod, Givat Shmuel (IL); Anthony Di Loreto, Markham (CA); Steve McDuff, Markham (CA); Kyle D. Robeson, North York (CA)

(21) Appl. No.: 16/392,686

(22) Filed: Apr. 24, 2019

Related U.S. Application Data
(63) Continuation of application No. 15/480,887, filed on Apr. 6, 2017.

(51) Int. Cl. G06Q 10/02; G06Q 50/30

(52) U.S. Cl. CPC G06Q 10/025; G06Q 50/30

(57) ABSTRACT

In an approach to ride chaining, one or more computer processors receive a request from a user for a transportation to a final destination in a vehicle. The one or more computer processors determine that a plurality of travel segments is required for the transportation to the final destination. The one or more computer processors reserve a first vehicle for a first travel segment of the plurality of travel segments to a first destination. The one or more computer processors, after commencement of the first travel segment and before completion of the first travel segment, determine a second travel segment of the plurality of travel segments to a second destination. The one or more computer processors reserve a second vehicle for the second travel segment of the plurality of travel segments.

### BACKGROUND OF THE INVENTION

The present invention relates generally to the field of transportation network providers, and more particularly to ride chaining for long distance travel.

The driving boom that existed after the 1950s has been on a decline. People have been driving fewer miles than our predecessors have since the 1970s. In addition, many people do not own a driver's license or even own a car. On the other hand, there has been an increase in public transportation consumption since 2011. Because of the decline in driving, transportation network providers grew to accommodate those individuals that prefer to ride rather than drive. The technical precursor behind ride sharing makes use of three advances in technology: global positioning system (GPS) navigation devices, smartphones, and social networks. All of these innovations are integrated into a network service, which can handle the driver payment and matching rides using a sophisticated travel planning algorithm.

Ride sharing works by assigning passengers to a driver so that the passengers can get to their predetermined destination, often within a metropolitan area. Potential passengers initiate a request via their smartphones by inputting their destination. A driver within the vicinity of the passenger receives the request and chooses to accept based on first in, first out (FIFO) order. The network service directs a passenger to a predetermined location once a driver has committed to selecting the passenger. Once the ride is complete, the network system automatically deducts the fee from a previously stored payment card in the passenger's profile. The social network aspect helps establish a trust and accountability between driver and passenger based on a feedback system. For example, a passenger can rate the driver based on promptness, courtesy, and cleanliness. In addition, a driver can rate the passenger on similar criteria to ensure a smooth and safe transaction.

### SUMMARY

Embodiments of the present invention disclose a computer implemented method for ride chaining. The method may include one or more computer processors receiving a request from a user via a passenger computing device using a ride sharing service for a transportation to a final destination in a vehicle based on a first location of the user, wherein the first location is based on a first received tracking location of the user associated with the passenger computing device; presenting, to the user, a travel plan associated with a plurality of travel segments is required for the transportation to the final destination based on a plurality of parameters, wherein the plurality of parameters include at least one of: a poor traffic condition, an adverse weather condition, a preference of the user, a maximum wait time preferred by the user, a type vehicle preferred by the user, a driver feedback rating preferred by the user, an availability of a driver, a maximum drive time accumulated per day by a driver, a maximum allotted drive time per segment by a driver, a maximum allotted drive time per day by a driver, a maximum wait time preferred by a driver, a preferred hours of operation by a driver, a maximum trip segment distance preferred by a driver, and a company policy that provides one or more constraints on a travel segment calculation; and wherein the plurality of parameters introduces one or more constraints on a travel segment calculation; reserving, a first vehicle for a first travel segment of the plurality of travel segments to a first destination, wherein the first destination is not the final destination, and where in a first location of the first vehicle is based on a first received tracking location of the first vehicle associated with a first computing device of the first vehicle utilizing the ride sharing service; determining, after the commencement to the first travel segment and before completion of the first travel segment, a second travel segment of the plurality of travel segments to a second destination based on a second location of the user, wherein the second location of the user is based on a second received tracking location of the user associated with the passenger computing device during the first segment but before completing the first segment and based on a second location of a second vehicle and wherein the second location of the second vehicle is based on a second received tracking location of the second vehicle associated with a computing device of the second vehicle utilizing the ride sharing service; responsive to determine the second travel segment of the plurality of travel segments to a second destination, reserving, the second vehicle for the second travel segment of the plurality of travel segments; notifying, the user via the passenger computing device utilizing the ride sharing service that the plurality of travel segments is required for the transportation to the final destination, further comprising: providing the user via the passenger computing device utilizing the ride sharing service with more than one route itinerary; and receiving a choice of a preferred route itinerary from the user via the passenger computing device; requesting an acceptance from the user via the passenger computing device utilizing the ride sharing service for an itinerary including the plurality of travel segments, wherein the acceptance further comprises the user sending an acknowledgement via the passenger computing device; receiving the acknowledgment from the user; determining whether the second destination of the second travel segment ends at the final destination; responsive to determine the second destination of the second travel segment does not end at the final destination, determining after commencement of the second travel segment and before the completing of the second travel segment, a third travel segment of the plurality of travel segments to a third destination based on a third received tracking location of the user during the second segment but before completing the second segment and is based on a third location of the third vehicle, wherein the third location of third vehicle is based on a third received tracking location of the third vehicle associated with a computing device of the third vehicle utilizing the ride sharing service; and responsive to determining the third travel segment of the plurality of travel segment to a third destination, reserving the third vehicle for the third travel segment to the third destination wherein the third travel segment ends at the final destination.

### BRIEF DESCRIPTION OF THE DRAWINGS

FIG. 1 is a functional block diagram illustrating a ride chaining data processing environment, in accordance with an embodiment of the present invention;

FIG. 2 is a flowchart depicting operational steps of a ride chaining program, on a server computer within the ride chaining data processing environment of FIG. 1, for dynamically reserving ride segments, in accordance with an embodiment of the present invention;

FIG. 3 depicts an example of a passenger travel trip sequence as determined by the ride chaining program within the ride chaining data processing environment of FIG. 1, in accordance with an embodiment of the present invention; and

FIG. 4 depicts a block diagram of components of the server computer executing the ride chaining program within the ride chaining data processing environment of FIG. 1 in accordance with an embodiment of the present invention.

### DETAILED DESCRIPTION

Ride sharing services have become a popular method of transportation for many urban dwellers. For example, a ride sharing service is used when a passenger does not have access to a car or mass transportation. However, a passenger may have difficulty finding transportation via a ride sharing service in various situations. For example, a ride sharing service may only cover short distances within a metropolitan area. One reason why a ride sharing service may only cover short distances is that drivers do not want to risk a long trip that has no returning passengers (i.e., empty backhaul). In another example, a ride sharing service may not allow passengers to travel to a rural area from a city. One reason why a ride sharing service is available in cities is that many drivers of a ride sharing service typically live and work in the city. Embodiments of the present invention recognize that improvements to current ride sharing processes may be made by enabling passengers to travel longer distances by dynamically chaining shorter segments into one seamless trip. This improvement lies in the invention's ability to dynamically pre-book at least one segment ahead as it may be difficult to book all drivers for all segments at the beginning of the trip, because there are many variables that can change throughout the journey. For example, variables such as adverse weather, poor traffic conditions, a late driver, indecisive passenger, etc. can change the projected outcome of the travel segment. Additionally, it may be undesirable to wait to book a subsequent segment at the end of each segment trip because the passenger may have to wait for the next driver to arrive or vice versa. Implementation of embodiments of the invention may take a variety of forms, and exemplary implementation details are discussed subsequently with reference to the Figures.

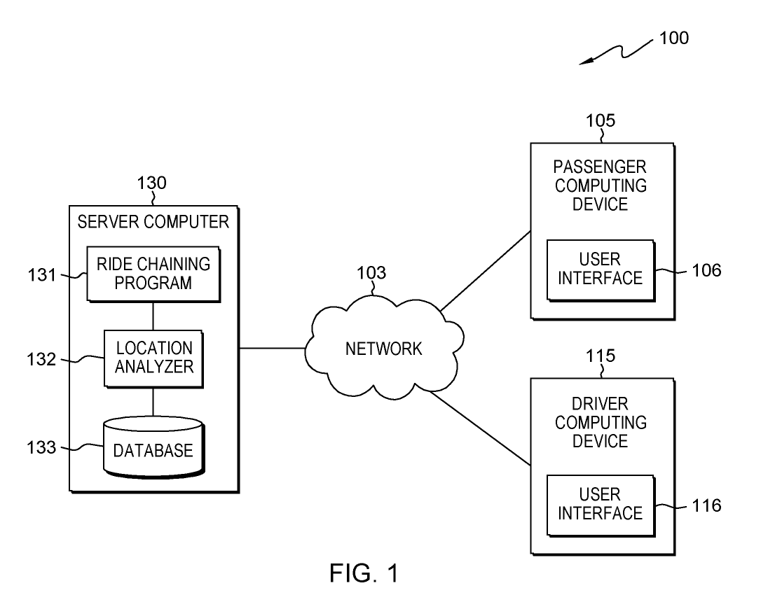

FIG. 1 is a functional block diagram illustrating a ride chaining data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Ride chaining data processing environment 100 includes server computer 130, passenger computing device 105, and driver computing device 115, all interconnected over network 103. Network 103 can be, for example, a telecommunications network, a local area network (LAN), a wide area network (WAN), such as the Internet, or a combination of the three, and can include wired, wireless, or fiber optic connections. Network 103 can include one or more wired and/or wireless networks that are capable of receiving and transmitting data, voice, and/or video signals, including multimedia signals that include voice, data, and video information. In general, network 103 can be any combination of connections and protocols that will support communications between server computer 130, passenger computing device 105, driver computing device 115, and other computing devices (not shown) within ride chaining data processing environment 100.

Server computer 130 can be a standalone computing device, a management server, a web server, a mobile computing device, or any other electronic device or computing system capable of receiving, sending, and processing data. In other embodiments, server computer 130 can represent a server computing system utilizing multiple computers as a server system, such as in a cloud computing environment. In another embodiment, server computer 130 can be a laptop computer, a tablet computer, a netbook computer, a personal computer (PC), a desktop computer, a personal digital assistant (PDA), a smart phone, or any other programmable electronic device capable of communicating with passenger computing device 105, driver computing device 115, and other computing devices (not shown) within ride chaining data processing environment 100 via network 103. In another embodiment, server computer 130 represents a computing system utilizing clustered computers and components (e.g., database server computers, application server computers, etc.) that act as a single pool of seamless resources when accessed within ride chaining data processing environment 100. Server computer 130 includes ride chaining program 131, location analyzer 132, and database 133.

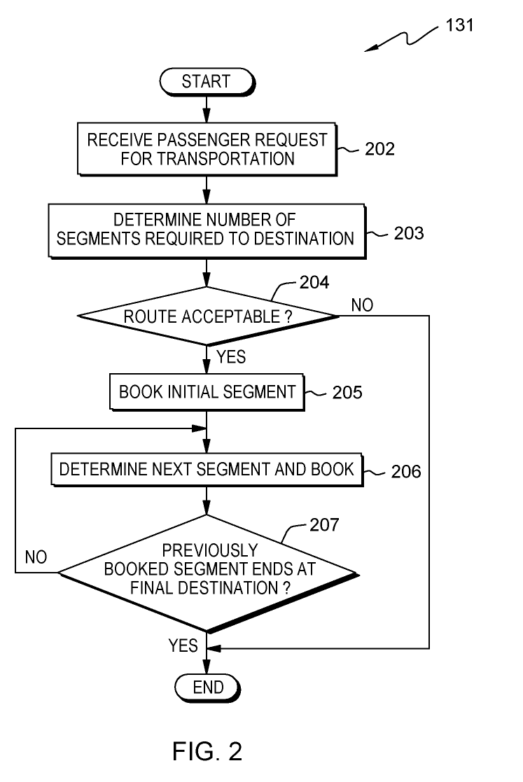

Ride chaining program 131 provides a transportation network service for long distance trips that may be outside a driver's home market or surpass a time limit allowed for a single driver. Ride chaining program 131 dynamically chains segments of trips together by continuously pre-reserving each segment based on different parameters, as needed, to create a seamless long distance travel arrangement. After receiving a passenger request for transportation, ride chaining program 131 analyzes the starting and destination location. Ride chaining program 131 determines if the trip requires chaining of multiple segments and, if so, then requests the acceptance from the passenger for a multiple segment itinerary. Ride chaining program 131 receives the passenger acknowledgment of trip acceptance and then books the initial segment. During the first segment of the trip, ride chaining program 131 determines the next sequence segment and dynamically books that segment. In another embodiment, ride chaining program 131 may receive a request for transportation for a package delivery. For example, a package may be delivered from one location to another using a similar method and manner as in the previously mentioned passenger use case scenario. Ride chaining program 131 is depicted and described in further detail with respect to FIG. 2.

Location analyzer 132 uses one or more of a plurality of techniques known in the art to determine a user's location. For example, if the passenger sends a request to ride chaining program 131 for transportation with passenger computing device 105, and passenger computing device 105 is a smart phone, then location analyzer 132 may determine the passenger's location based on a global positioning service (GPS) within the smart phone. In another example, if the passenger sends a request to ride chaining program 131 for transportation with passenger computing device 105 and passenger computing device 105 is a laptop computer, then location analyzer 132 may determine the passenger's location based on cookies associated with the internet protocol (IP) address of the laptop computer.

Database 133 is a repository for data used by ride chaining program 131. A database is an organized collection of data. Database 133 uses one or more of a plurality of techniques known in the art to store information about the passenger and driver parameters. Database 133 can be implemented with any type of storage device capable of storing data and configuration files that can be accessed and utilized by server computer 130, such as a database server, a hard disk drive, or a flash memory. Database 133 stores driver parameters, for example, duration of a current drive and drive time accumulated per day. Database 133 may also store one or more ride-sharing company policies on, for example, maximum allotted drive time per segment and per day. Database 133 may also store passenger parameters, for example, payment information and preferences, such as vehicle type, driver feedback rating, etc.

Passenger computing device 105 and driver computing device 115 can each be a laptop computer, a tablet computer, a smart phone, or any programmable electronic mobile device capable of communicating with various components and devices within ride chaining data processing environment 100, via network 103. Passenger computing device 105 and driver computing device 115 may each be a wearable computer. Wearable computers are miniature electronic devices that may be worn by the bearer under, with, or on top of clothing, as well as in or connected to glasses, hats, or other accessories. Wearable computers are especially useful for applications that require more complex computational support than merely hardware coded logics. In general, passenger computing device 105 and driver computing device 115 each represent any programmable electronic mobile device or combination of programmable electronic mobile devices capable of executing machine readable program instructions and communicating with other computing devices (not shown) within ride chaining data processing environment 100 via a network, such as network 103. Passenger computing device 105 includes an instance of user interface 106. Driver computing device 115 includes an instance of user interface 116. In one embodiment, driver computing device 115 may directly be integrated into a vehicle's computing system. In the embodiment, the vehicle may be an autonomous self-driving vehicle.

User interface 106 provides an interface to ride chaining program 131 on server computer 130 for a user of passenger computing device 105. In one embodiment, user interface 106 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. In another embodiment, user interface 106 may also be mobile application software that provides an interface between passenger computing device 105 and server computer 130. Mobile application software, or an “app,” is a computer program designed to run on smart phones, tablet computers, wearable computers and other mobile devices. User interface 106 enables a passenger to request transportation from ride chaining program 131 via passenger computing device 105. User interface 106 may also enable the user of passenger computing device 105 to register with ride chaining program 131. User interface 106 may also enable the user of passenger computing device 105 to store parameters, preferences, and constraints, for example, a user can input payment information and vehicle type preference. In another embodiment, a user may request a package delivery via user interface 106. For example, a package may be delivered from one location to another using a similar method and manner as a typical passenger trip scenario.

User interface 116 provides an interface to ride chaining program 131 on server computer 130 for a user of driver computing device 115. In one embodiment, user interface 116 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. In another embodiment, user interface 116 may also be mobile app software that provides an interface between driver computing device 115 and server computer 130. User interface 116 enables a user of driver computing device 115 to accept a transportation request from ride chaining program 131. User interface 116 may also enable the user of driver computing device 115 to register with ride chaining program 131. User interface 116 may also enable the user of driver computing device 115 to store a plurality of preferences. For example, the user of driver computing device 115 may input one or more driver preferences, such as preferred hours of operation and maximum drive time per segment.

FIG. 2 is a flowchart depicting operational steps of ride chaining program 131, on server computer 130 within ride chaining data processing environment 100 of FIG. 1, for dynamically reserving ride segments, in accordance with an embodiment of the present invention.

Ride chaining program 131 receives a passenger request for transportation (step 202). In one embodiment, ride chaining program 131 receives the request for transportation from passenger computing device 105, where the request for transportation includes a current location of the user and a destination location desired by the user. In addition to the destination location, the request may also include, but is not limited to, a preference for a vehicle type and a driver rating. In an embodiment, ride chaining program 131 may store user current location and final destination in database 133. In an embodiment, ride chaining program 131 reviews a passenger profile corresponding to the user of passenger computer device 105 to determine whether there are applicable preferences such as a maximum trip duration and a maximum trip segment distance. In another embodiment, ride chaining program 131 may also determine availability of credit card information and any applicable discounts. In another embodiment, ride chaining program 131 may receive simultaneous requests for transportation to the same destination from a plurality of users, i.e., ride pooling.

Ride chaining program 131 determines a number of segments required to reach the destination (step 203). In one embodiment, ride chaining program 131 may determine that more than one segment is required because the distance or time to reach the destination exceeds a predefined threshold. Ride chaining program 131 calculates the number of segments required to complete the trip based on a plurality of parameters, utilizing one or more techniques known in the art. One or more of the plurality of parameters can affect a calculation within an algorithm of ride chaining program 131 by introducing a constraint that the program may be required to incorporate while determining available travel segments. For example, ride chaining program 131 determines whether one or more company policies exist that provide additional constraints on segment calculation, such as a ride sharing company prohibiting a driver from driving more than four hours on one segment. In another example, one of the plurality of parameters may be a preference on a maximum wait time between each travel segment of the passenger. In yet another example, ride chaining program 131 determines a preference of one or more drivers, such as maximum trip duration and maximum trip segment distance. In yet another example, ride chaining program 131 determines one or more current locations of drivers, using location analyzer 132, as well as determining the availability of drivers, in order to calculate a possible route. In one embodiment, ride chaining program 131 may calculate more than one route and may determine a preferred route based on a passenger preference. For example, a passenger may prefer to ride no longer than ten hours for the duration of the trip. In another example, a passenger may prefer to ride in a sedan instead of a minivan. In another embodiment, ride chaining program 131 may determine the number of segments required for a trip after receiving several requests from users with the same destination. For example, more than one user may share one or more segments but not the same starting origination or final destination, i.e., ride sharing.

Ride chaining program 131 determines whether route is acceptable to the passenger (decision block 204). Ride chaining program 131 notifies the passenger of a proposed route itinerary, which includes multiple segments, via user interface 106. In one embodiment, ride chaining program 131 may provide the passenger more than one route itinerary from which the passenger can choose a preferred route. For example, the passenger may prefer a shortest route based on time to the final destination and the passenger may provide the choice to ride chaining program 131. In another example, the passenger may prefer a longer route that has the least number of segments. In another embodiment, ride chaining program 131 informs the passenger that the itinerary may be subject to change since ride chaining program 131 dynamically books the follow-on segments. Ride chaining program 131 requests acceptance from the passenger for the proposed route itinerary. Ride chaining program 131 receives a response from the passenger via user interface 106.

If ride chaining program 131 determines that route is not acceptable for the passenger (“no” branch, decision block 204), then ride chaining program 131 ends. In one embodiment, if ride chaining program 131 receives a response from passenger indicating that the route is not acceptable, then ride chaining program 131 may request a reason from the passenger in order to attempt to accommodate the passenger with an alternate route. For example, if the passenger indicates that the proposed trip includes a landmark that the passenger wishes to avoid, then ride chaining program 131 can return to step 203 to calculate an alternative itinerary that uses the new constraint.

If ride chaining program 131 determines that route is acceptable for the passenger (“yes” branch, decision block 204), then ride chaining program 131 proceeds to reserves the initial segment (step 205). In one embodiment, if ride chaining program 131 receives a response from the passenger indicating that the route is acceptable, then ride chaining program 131 books a driver for the initial segment. For example, ride chaining program 131 sends a trip request to a specific driver and the driver may accept the request via user interface 116. In addition, ride chaining program 131 may direct the passenger to a designated pickup location of that driver. In another embodiment, if ride chaining program 131 receives a response from the passenger indicating that the route is acceptable and if all drivers along the path are available then ride chaining program 131 may book all segments of the trip. For example, ride chaining program 131 may send a trip request to all drivers along the route and the drivers may accept the request via user interface 116. In another example, ride chaining program 131 may send a trip request to one or more autonomous vehicles along the route, and the autonomous vehicles may accept the requests via user interface 116.

Ride chaining program 131 determines the next segment of the trip and books the segment (step 206). In one embodiment, ride chaining program 131 calculates the next segment by comparing distance already traveled in the initial segment against the remaining distance and utilizing a plurality of parameters. For example, ride chaining program 131 may determine current passenger location using location analyzer 132 in order to estimate the arrival time at the initial segment destination. In another example, ride chaining program 131 may determine the availability of a driver along the route. In yet another example, ride chaining program 131 may utilize stored parameters, such as driver preference and company policy, from database 133, in order to determine subsequent segments required for the remainder of the trip such as the maximum preferred wait time by the next driver. In a further example, ride chaining program 131 may take into account additional variables, such as poor traffic conditions, adverse weather, etc. which may delay arrival at the destination. Based on the calculation, ride chaining program 131 reserves the next segment by confirming a driver's acceptance of the subsequent segment. In one embodiment, ride chaining program 131 receives a confirmation from the driver. For example, ride chaining program 131 receives an acceptance from the driver via user interface 116. In one embodiment, ride chaining program 131 notifies the passenger of the next segment destination. For example, ride chaining program 131 alerts the passenger, via user interface 106, with techniques known in the art for pushing a notification to a mobile computing device. In one embodiment, ride chaining program 131 may book more than one of the remaining segments while the passenger is en route to the initial segment destination. In yet another embodiment, ride chaining program 131 may determine that there is a gap, i.e., no available driver for the next segment, alerts the passenger, and requests the passenger to choose an acceptable drop off location. For example, while traveling on a particular segment, if ride chaining program 131 determines that there are no subsequent segments available for the passenger to reach their final destination, then ride chaining program 131 may instruct the passenger to disembark at a safe location or a close mass transit hub.

Ride chaining program 131 determines if the previously booked segment ends at the final destination (decision block 207). In an embodiment, ride chaining program 131 compares the destination of the segment booked in step 206 to the original request from the passenger for transportation. If ride chaining program 131 determines that the previously booked segment ends at the final destination (“yes” branch, decision block 207), then ride chaining program 131 ends. In an embodiment, upon arrival at the destination, ride chaining program 131 instructs the passenger to disembark from the vehicle. For example, ride chaining program 131 may notify the passenger, via user interface 106, that the trip is complete. Furthermore, ride chaining program 131 may request the passenger to confirm that the trip is complete via user interface 106. In addition, ride chaining program 131 may instruct the passenger to pay for the ride using previously stored payment information such as a credit card from database 133, via user interface 106.

If ride chaining program 131 determines if the previously booked segment does not end at the final destination (“no” branch, decision block 207), then ride chaining program 131 returns to step 206 to determine the next segment of the trip. In one embodiment, ride chaining program 131 may receive a request from a passenger who wishes to terminate the trip and not continue on the next segment. For example, ride chaining program 131 may receive a request when the passenger taps a button on user interface 106 to terminate the trip prematurely. Furthermore, ride chaining program 131 may instruct the passenger to disembark at the end of that segment.

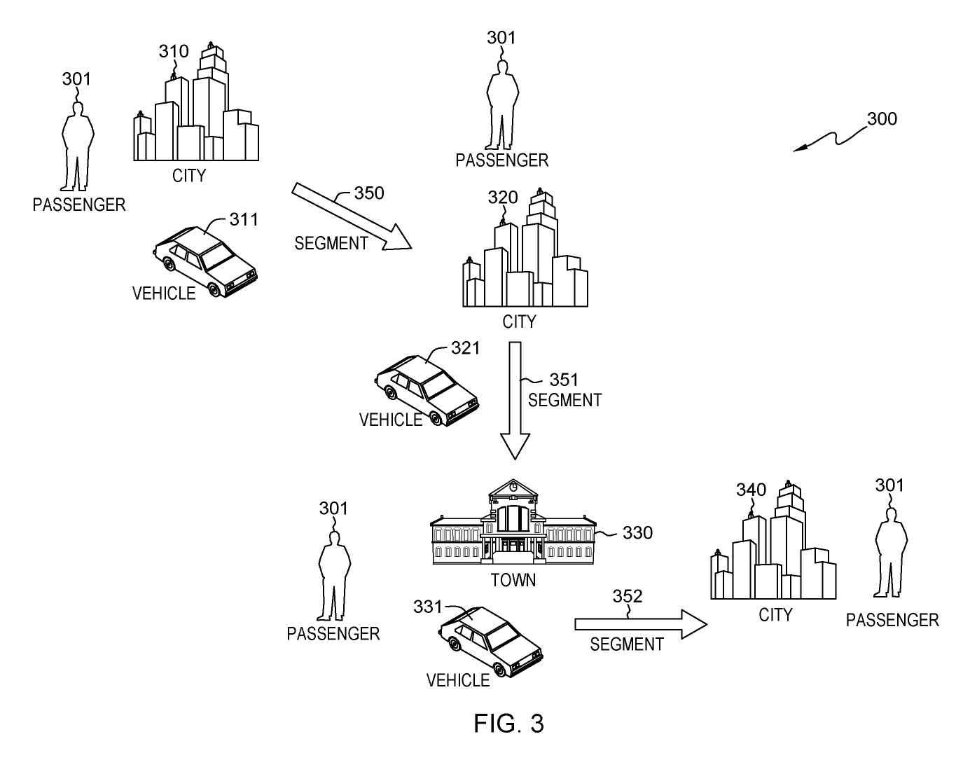

FIG. 3 depicts an example of a passenger travel trip sequence 300 as determined by ride chaining program 131 within ride chaining data processing environment 100 of FIG. 1, in accordance with an embodiment of the present invention. In the depicted embodiment, passenger 301 requests a trip from ride chaining program 131 to travel from city 310 to city 340. Ride chaining program 131 determines that three segments are required to complete the trip, as discussed with respect to step 203 of FIG. 2. Ride chaining program 131 notifies passenger 301 that chaining of three segments are needed and requests acceptance from passenger 301, as discussed with respect to decision block 204 of FIG. 2. Upon receiving the acceptance, ride chaining program 131 reserves segment 350 from city 310 to city 320 in vehicle 311, as discussed with respect to step 205 FIG. 2. After commencement of travel to city 320, ride chaining program 131 dynamically books vehicle 321 for segment 351, from city 320 to town 330, as discussed with respect to step 206 of FIG. 2.

Upon arriving at city 320, ride chaining program 131 may instruct passenger 301 to disembark from vehicle 311 and enter vehicle 321. Ride chaining program 131 determines if segment 351 ends at city 340, i.e., the final destination, as discussed with respect to decision block 207 of FIG. 2. After commencement of travel to town 330, upon determining that segment 351 does not end at city 340, ride chaining program 131 dynamically books segment 352.

Upon arriving at town 330, ride chaining program 131 may instruct passenger 301 to disembark from vehicle 321 and enter vehicle 331. Ride chaining program 131 determines if segment 352 ends at city 340, i.e., the final destination, as discussed with respect to decision block 207 of FIG. 2. Upon determining that segment 352 does end at city 340, ride chaining program 131 ends.

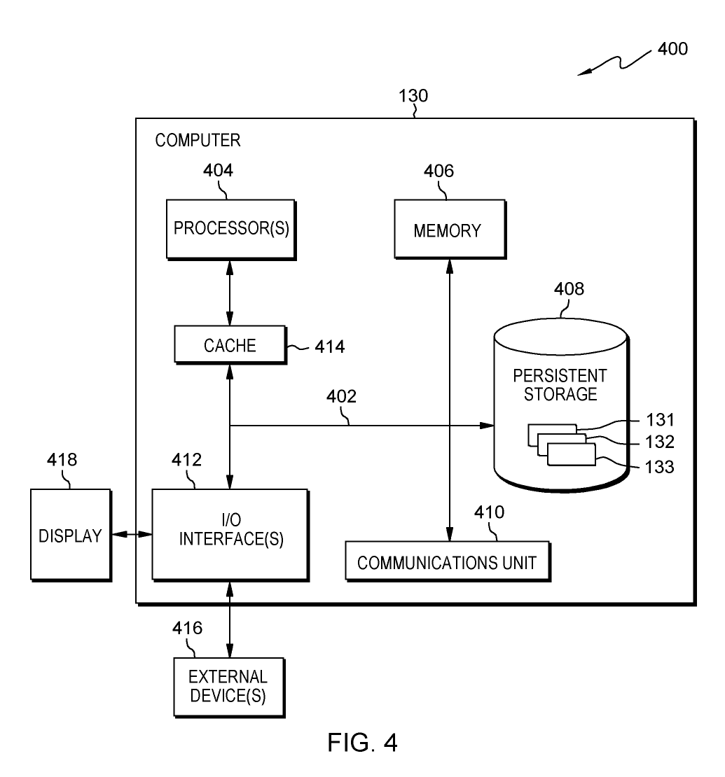

FIG. 4 depicts a block diagram of components of server computer 130 within ride chaining data processing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

Server computer 130 can include processor(s) 404, cache 414, memory 406, persistent storage 408, communications unit 410, input/output (I/O) interface(s) 412 and communications fabric 402. Communications fabric 402 provides communications between cache 414, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM). In general, memory 406 can include any suitable volatile or non-volatile computer readable storage media. Cache 414 is a fast memory that enhances the performance of processor(s) 404 by holding recently accessed data, and data near recently accessed data, from memory 406.

Program instructions and data used to practice embodiments of the present invention, e.g., ride chaining program 131, location analyzer 132, and database 133 can be stored in persistent storage 408 for execution and/or access by one or more of the respective processor(s) 404 of server computer 130 via memory 406. In this embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including resources of passenger computing device 105 or driver computing device 115. In these examples, communications unit 410 includes one or more network interface cards. Communications unit 410 may provide communications through the use of either or both physical and wireless communications links. Ride chaining program 131, location analyzer 132, and database 133 may be downloaded to persistent storage 408 of server computer 130 through communications unit 410.

I/O interface(s) 412 allows for input and output of data with other devices that may be connected to server computer 130. For example, I/O interface(s) 412 may provide a connection to external device(s) 416 such as a keyboard, a keypad, a touch screen, a microphone, a digital camera, and/or some other suitable input device. External device(s) 416 can also include portable computer readable storage media such as, for example, thumb drives, portable optical or magnetic disks, and memory cards. Software and data used to practice embodiments of the present invention, e.g., ride chaining program 131, location analyzer 132, and database 133 on server computer 130, can be stored on such portable computer readable storage media and can be loaded onto persistent storage 408 via I/O interface(s) 412. I/O interface(s) 412 also connect to a display 418.

Display 418 provides a mechanism to display data to a user and may be, for example, a computer monitor or the lenses of a head mounted display. Display 418 can also function as a touchscreen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method for ride chaining, the method comprising:
receiving a request from a user via a passenger computing device using a ride sharing service for a transportation to a final destination in a vehicle based on a first location of the user, wherein the first location is based on a first received tracking location of the user associated with the passenger computing device;
presenting, to the user, a travel plan associated with a plurality of travel segments is required for the transportation to the final destination based on a plurality of parameters, wherein the plurality of parameters include at least one of: a poor traffic condition, an adverse weather condition, a preference of the user, a maximum wait time preferred by the user, a type vehicle preferred by the user, a driver feedback rating preferred by the user, an availability of a driver, a maximum drive time accumulated per day by a driver, a maximum allotted drive time per segment by a driver, a maximum allotted drive time per day by a driver, a maximum wait time preferred by a driver, a preferred hours of operation by a driver, a maximum trip segment distance preferred by a driver, and a company policy that provides one or more constraints on a travel segment calculation;
and wherein the plurality of parameters introduces one or more constraints on a travel segment calculation;
reserving, a first vehicle for a first travel segment of the plurality of travel segments to a first destination, wherein the first destination is not the final destination, and where in a first location of the first vehicle is based on a first received tracking location of the first vehicle associated with a first computing device of the first vehicle utilizing the ride sharing service;
determining, after the commencement to the first travel segment and before completion of the first travel segment, a second travel segment of the plurality of travel segments to a second destination based on a second location of the user, wherein the second location of the user is based on a second received tracking location of the user associated with the passenger computing device during the first segment but before completing the first segment and based on a second location of a second vehicle and wherein the second location of the second vehicle is based on a second received tracking location of the second vehicle associated with a computing device of the second vehicle utilizing the ride sharing service;
responsive to determine the second travel segment of the plurality of travel segments to a second destination, reserving, the second vehicle for the second travel segment of the plurality of travel segments;
notifying, the user via the passenger computing device utilizing the ride sharing service that the plurality of travel segments is required for the transportation to the final destination, further comprising:
providing the user via the passenger computing device utilizing the ride sharing service with more than one route itinerary; and
receiving a choice of a preferred route itinerary from the user via the passenger computing device;
requesting an acceptance from the user via the passenger computing device utilizing the ride sharing service for an itinerary including the plurality of travel segments, wherein the acceptance further comprises the user sending an acknowledgement via the passenger computing device;
receiving the acknowledgment from the user;
determining whether the second destination of the second travel segment ends at the final destination;
responsive to determine the second destination of the second travel segment does not end at the final destination, determining after commencement of the second travel segment and before the completing of the second travel segment, a third travel segment of the plurality of travel segments to a third destination based on a third received tracking location of the user during the second segment but before completing the second segment and is based on a third location of the third vehicle, wherein the third location of third vehicle is based on a third received tracking location of the third vehicle associated with a computing device of the third vehicle utilizing the ride sharing service; and
responsive to determining the third travel segment of the plurality of travel segment to a third destination, reserving the third vehicle for the third travel segment to the third destination wherein the third travel segment ends at the final destination.
